(19) United States
(12) Patent Application Publication
(10) Pub. No.: US 2025/0136149 A1
(43) Pub. Date: May 1, 2025

(54) SYSTEMS AND METHODS FOR ENHANCING SENSING CAPABILITIES OF AN AUTONOMOUS VEHICLE

(71) Applicant: Torc Robotics, Inc., Blacksburg, VA (US)

(72) Inventors: Joseph Fox-Rabinovitz, Austin, TX (US); William Davis, Austin, TX (US); Akshay Pai Raikar, Austin, TX (US)

(21) Appl. No.: 18/494,609

(22) Filed: Oct. 25, 2023

(51) Int. Cl. B60W 60/00

(52) U.S. Cl. CPC B60W 60/0011; B60W 2422/00

(57) ABSTRACT

A method for enhancing the sensing capabilities of an autonomous vehicle. The method includes extending an extension assembly mounted to the autonomous vehicle to position one or more sensors above the autonomous vehicle and receiving, from the one or more sensors, at least one sensor signal representing one or more vehicle environment conditions surrounding the autonomous vehicle. The method also includes generating a vehicle state for the autonomous vehicle based at least on a location of the autonomous vehicle, the vehicle state comprising the one or more vehicle environment conditions.

### TECHNICAL FIELD

The field of the disclosure relates generally to autonomous vehicles and, more specifically, to systems and methods for use in enhancing sensing capabilities of an autonomous vehicle using sensor data of surrounding vehicle environment conditions.

### BACKGROUND OF THE INVENTION

At least some known autonomous vehicles may employ four fundamental technologies: perception, localization, behaviors and planning, and motion control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies may process features in the sensed environment to correlate, or register, those features to known features on a map. Additionally, localization technologies may use data received from sensors and/or various odometry information sources to generate an estimated vehicle location in the world.

Behaviors and planning technologies determine how to move through the sensed environment to reach a planned destination, processing data representing the sensed environment and localization or mapping data to plan maneuvers and routes to reach the planned destination. Motion control technologies translate the output of behaviors and planning technologies into concrete commands to the vehicle via the vehicle interface provided by the internal electronic control unit.

One element of perception for autonomous vehicles is object detection and understanding. During operation, a vehicle may detect objects indicative of specific traffic and/or road conditions, such as objects associated with construction and/or road closure. However, without appropriate behaviors and planning input into motion control, an autonomous vehicle that detects these objects may be unable to navigate the traffic conditions to continue movement towards a planned destination. Accordingly, there exists a need for systems and methods for detecting vehicle environment conditions surrounding an autonomous vehicle to enhance sensing capabilities of the vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

The embodiments described herein relate to a system for enhancing the sensing capabilities of an autonomous vehicle. The system includes a detection system comprising an extension assembly for mounting on the autonomous vehicle and one or more sensors and an autonomy system. The autonomy system includes a controller, a processor, and a memory device, the memory device storing instructions that, when executed by the processor, cause the controller to extend the extension assembly to position the one or more sensors above the autonomous vehicle, receive, from the one or more sensors, at least one sensor signal representing one or more vehicle environment conditions surrounding the autonomous vehicle, and generate a vehicle state for the autonomous vehicle based at least on a location of the autonomous vehicle, the vehicle state comprising the one or more vehicle environment conditions.

The embodiments described herein also relate to a method for enhancing the sensing capabilities of an autonomous vehicle. The method includes extending an extension assembly mounted to the autonomous vehicle to position one or more sensors above the autonomous vehicle, receiving, from the one or more sensors, at least one sensor signal representing one or more vehicle environment conditions surrounding the autonomous vehicle, and generating a vehicle state for the autonomous vehicle based at least on a location of the autonomous vehicle, the vehicle state comprising the one or more vehicle environment conditions.

The embodiments described herein further relate to an autonomy system for enhancing the sensing capabilities of an autonomous vehicle. The autonomy system includes a controller, a processor, and a memory device, the memory device storing instructions that when executed by the processor cause the controller to extend an extension assembly mounted to the autonomous vehicle to position one or more sensors above the autonomous vehicle, receive, from the one or more sensors, at least one sensor signal representing one or more vehicle environment conditions surrounding the autonomous vehicle, and generate a vehicle state for the autonomous vehicle based at least on a location of the autonomous vehicle and the one or more vehicle environment conditions.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a front view of a vehicle including two configurations of an embodiment of a detection system in a stowed configuration.

FIG. 2 is a side view of the vehicle shown in FIG. 1.

FIG. 3 is a front view of the vehicle shown in FIG. 1, including the detection system in an extended configuration.

FIG. 4 is a side view of the vehicle shown in FIG. 3.

FIG. 5 is a front view of a vehicle including another embodiment of a detection system in a stowed configuration.

FIG. 6 is a side view of the vehicle shown in FIG. 5.

FIG. 7 is a front view of the vehicle shown in FIG. 5, including the detection system in an extended configuration.

FIG. 8 is a side view of the vehicle shown in FIG. 7.

FIG. 9 is a front view of a vehicle including yet another embodiment of a detection system in a stowed configuration.

FIG. 10 is a side view of the vehicle shown in FIG. 9.

FIG. 11 is a front view of the vehicle shown in FIG. 9, including the detection system in an extended configuration.

FIG. 12 is a side view of the vehicle shown in FIG. 11.

FIG. 13 a front view of a vehicle including still another embodiment of a detection system in a stowed configuration.

FIG. 14 is a side view of the vehicle shown in FIG. 13.

FIG. 15 is a top view of the detection system shown in FIG. 13.

FIG. 16 is a front view of the vehicle shown in FIG. 13, including the detection system in an extended configuration.

FIG. 17 is a side view of the vehicle shown in FIG. 16.

FIG. 18 a front view of a vehicle including a further embodiment of a detection system.

FIG. 19 is a side view of the vehicle shown in FIG. 18.

FIG. 20 is a schematic of an autonomy system for use with a vehicle including a detection system.

FIG. 21 is a flow diagram of a method for enhancing sensing capabilities of a vehicle.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Embodiments of the disclosed system enhance sensing capabilities of an autonomous vehicle using sensor data of surrounding vehicle environment conditions. The disclosed system includes an extension assembly for mounting to the vehicle and one or more sensors. The extension assembly is extended to position the one or more sensors above the vehicle to receive data of vehicle environment conditions surrounding the vehicle. Based on the vehicle environment conditions data and a location of the vehicle, a vehicle state is generated for the autonomous vehicle.

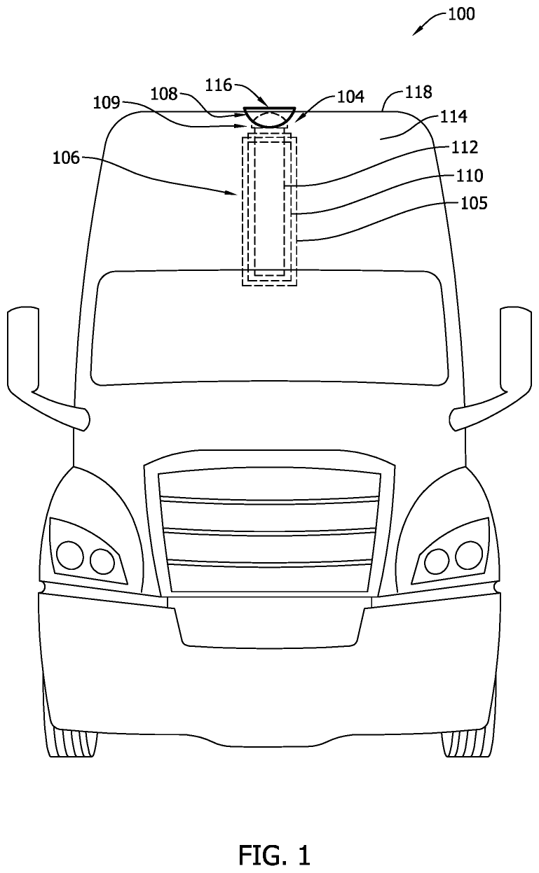

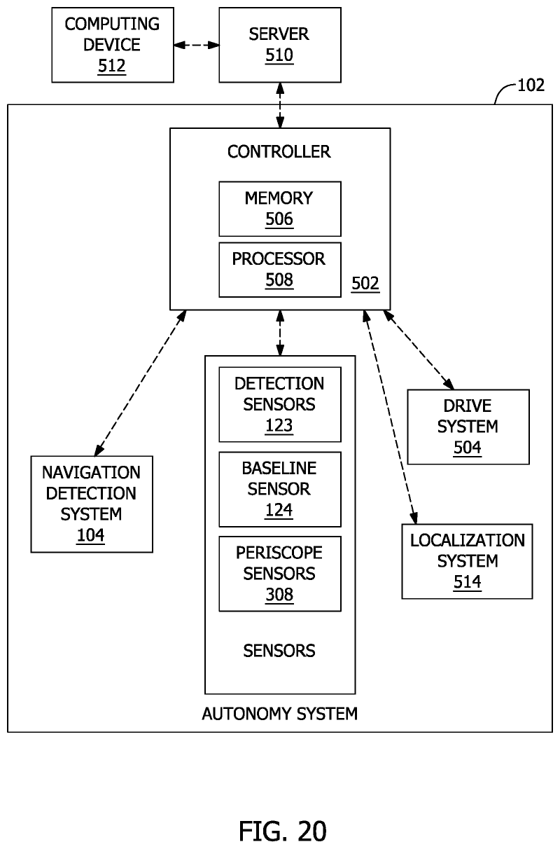

FIGS. 1-4 are views of a vehicle 100. The vehicle 100 is configured for autonomous operation via an autonomy system 102 (shown in FIG. 20). The vehicle 100 includes a detection system 104 for perceiving vehicle environment conditions around the autonomous vehicle, including, but not limited to, traffic conditions and road conditions. The detection system 104 collects data indicative of the vehicle environment conditions surrounding the vehicle 100 to generate a vehicle state based on at least a location of the vehicle 100. The vehicle state includes the vehicle environment conditions and may be used by the autonomy system 102 to further control the vehicle 100. For example, the data included in the vehicle state may be used for, but is not limited to being used for, controlling movement of the vehicle 100, planning movement of the vehicle 100, and/or positioning the detection system 104 (e.g., raising or lowering the detection system 104). The vehicle state may include, but is not limited to, data representative of vehicle position, vehicle orientation, vehicle velocity, and/or vehicle acceleration.

As shown in FIGS. 1-4, a first embodiment of the detection system 104 includes a base member 105, an extension assembly 106, and a detection assembly 108 coupled to a top end 109 of the extension assembly 106. The extension assembly 106 includes an outer extension member 110 that slides within the base member 105 and an inner extension member 112 that slides within the outer extension member 110. In some embodiments, the extension assembly 106 may include one or more extension members in addition to the inner extension member 112 and the outer extension member 110. That is, the illustration of the extension assembly 106 as including only two extension members, the inner extension member 112 and the outer extension member 110, is intended as illustrative, and is not meant to be limiting.

The base member 105, the outer extension member 110, and the inner extension member 112 form a telescoping assembly, in that the sliding of the outer extension member 110 and the inner extension member 112 raise and lower the detection assembly 108 at the top end 109 of the extension assembly 106. In some embodiments, the telescoping assembly may include one or more actuators (e.g., an electrical motor with appropriate gearing, a hydraulic actuator, a pneumatic actuator, etc.) to extend the outer extension member 110 and/or the inner extension member 112. In other embodiments, the telescoping assembly may include one or more actuators (such as, but not limited to, one or more springs) and/or magnets to extend the outer extension member 110 and/or the inner extension member 112.

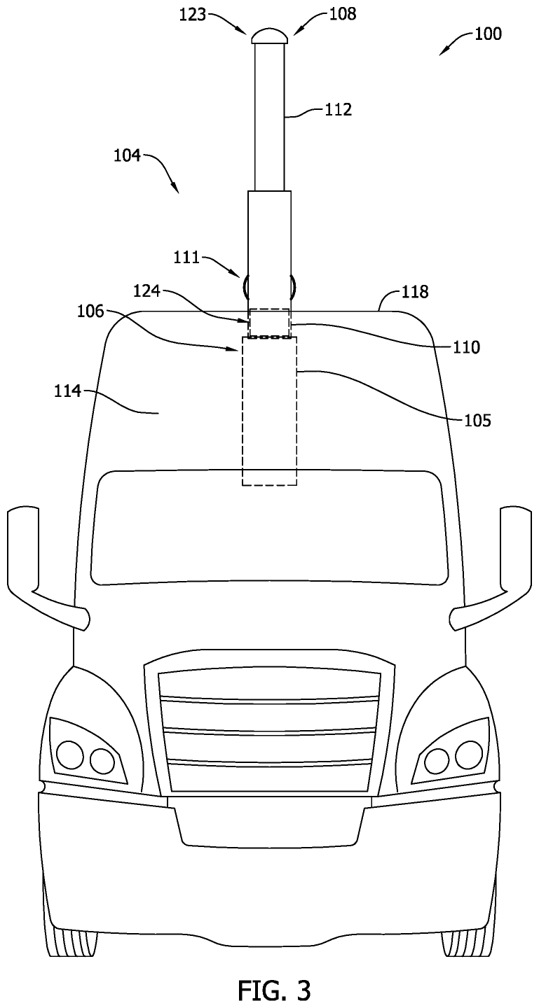

The extension assembly 106 may include one or more nesting members 111 (shown in FIG. 3) for engagement of the outer extension member 110 with the base member 105 and/or the inner extension member 112 with the outer extension member 110. For example, when the outer extension member 110 is extended through the base member 105 and/or the inner extension member 112 is extended through the outer extension member 110, the one or more nesting members 111 may secure the telescoping members in place at a maximum extension to facilitate improving the stability of the extension assembly 106.

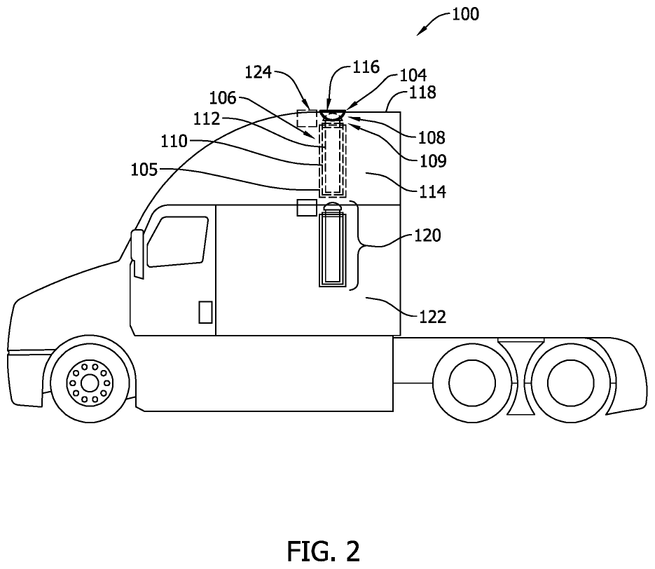

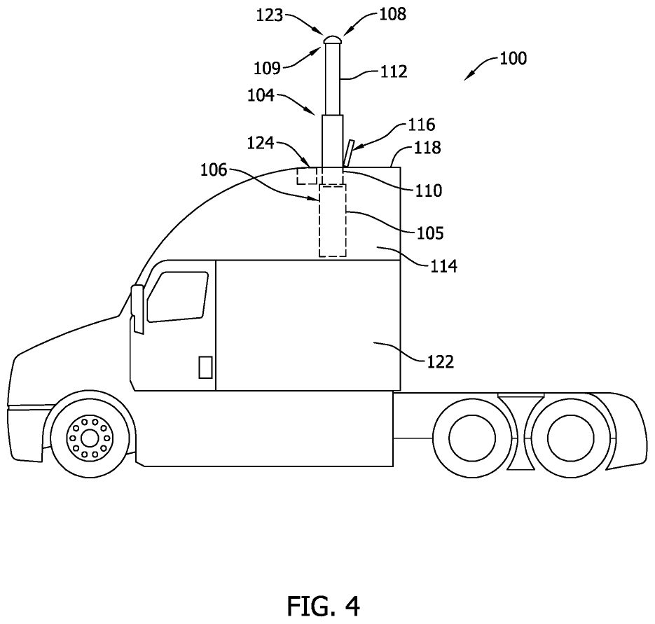

The detection system 104 moves between a stowed configuration, shown in FIGS. 1 and 2, and an extended configuration, shown in FIGS. 3 and 4. In the stowed configuration, the outer extension member 110 is nested within the base member 105 and the inner extension member 112 is nested within the outer extension member 110. The detection system 104 may be positioned within an upper cab area 114 of the vehicle 100. A hatch 116 may be located on an uppermost surface 118 of the upper cab area 114 to close over the detection system 104 in the stowed configuration. The upper cab area 114 may include an airfoil. In embodiments including the hatch 116, the hatch 116 may be spring-loaded or mechanically actuated to open when the detection system 104 is moved into the extended configuration. In the stowed configuration, the hatch 116 may facilitate protecting the detection system 104 from precipitation, foreign particles, and/or weather damage.

The position of the detection system 104 within the upper cab area 114 is intended as illustrative, and is not meant to be limiting. The detection system 104 may be positioned elsewhere on the vehicle 100, such as, but not limited to, in an embedded position 120 within a main cab area 122 (shown in FIG. 2) below the upper cab area 114. For example, the detection system 104 may be in the embedded position 120 within the main cab area 122 if the vehicle 100 does not include an airfoil. Additionally, the vehicle 100 may have more than one detection system 104, with the single detection system 104 intended as illustrative.

The detection assembly 108 includes one or more sensors 123. The one or more sensors 123 may be any sensor known in the art that facilitates the collection of data as related to the detection system 104. For example, the one or more sensors 123 may include, but are not limited to, one or more angular position sensors, one or more proximity sensors, one or more linear position sensors, one or more ultrasound sensors, one or more cameras, one or more LiDAR sensors, one or more RADAR cameras, one or more inertial measurement units (IMUs), and/or one or more stereo cameras (to collect three-dimensional images).

Additionally, the detection system 104 may include a baseline sensor 124 positioned proximate the uppermost surface 118 of the upper cab area 114. The autonomy system 102 (shown in FIG. 20) may receive data from both the one or more sensors 123 and the baseline sensor 124 to determine a height, a position, and/or an orientation of the detection assembly 108 and/or the extension assembly 106. Additionally, the autonomy system 102 (shown in FIG. 20) may receive data from at least one of the one or more sensors 123 and the baseline sensor 124 to detect impediments to extending the extension assembly 106 prior to extension. For example, the one or more sensors 123 and/or the baseline sensor may detect the presence of objects and/or features that would impede the extension of the extension assembly 106 above the vehicle 100, such as, but not limited to, a building feature, a tree, a flying object such as a drone, a bridge, an overpass, a traffic light, and/or a traffic sign. The baseline sensor 124 may be any sensor known in the art that facilitates the collection of data as related to the detection system 104. For example, the baseline sensor 124 may be a position sensor, a linear position sensor, a camera (including, but not limited to, an ocular camera and a stereo camera), and/or a LiDAR sensor.

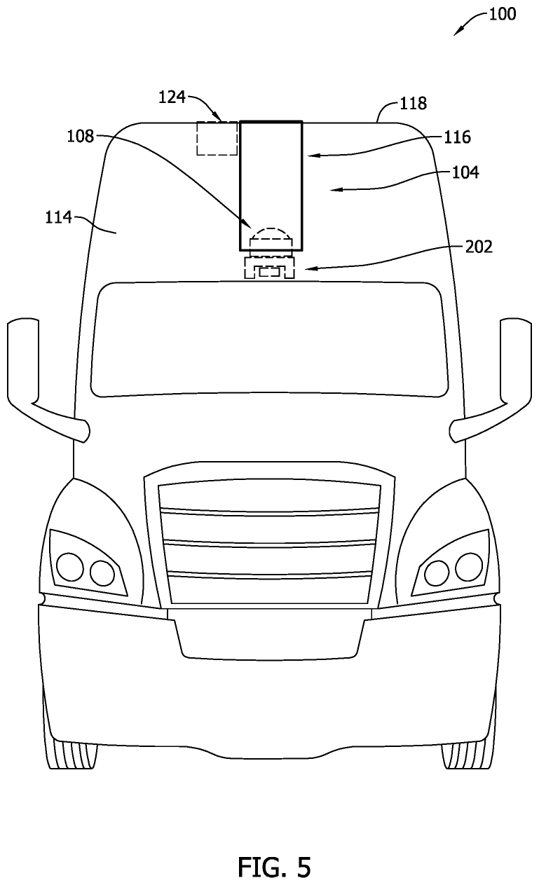

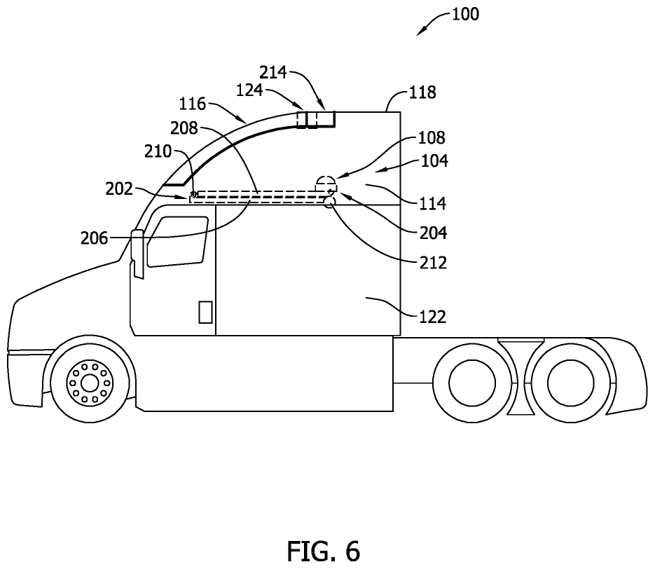

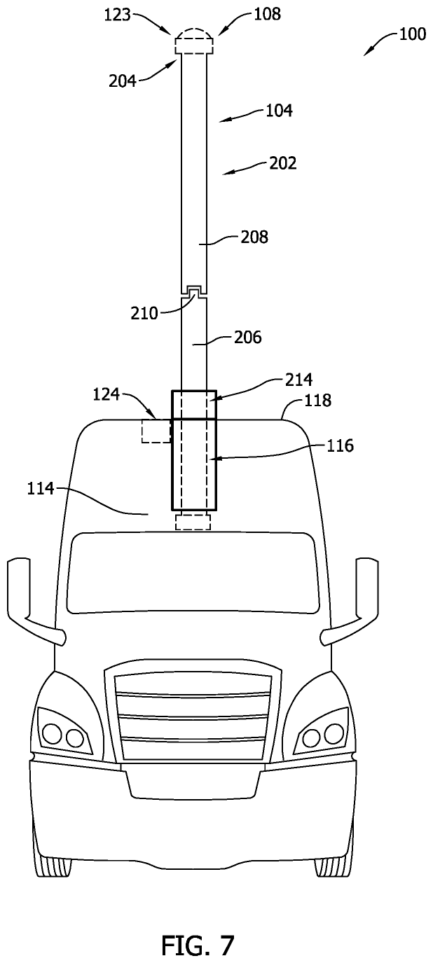

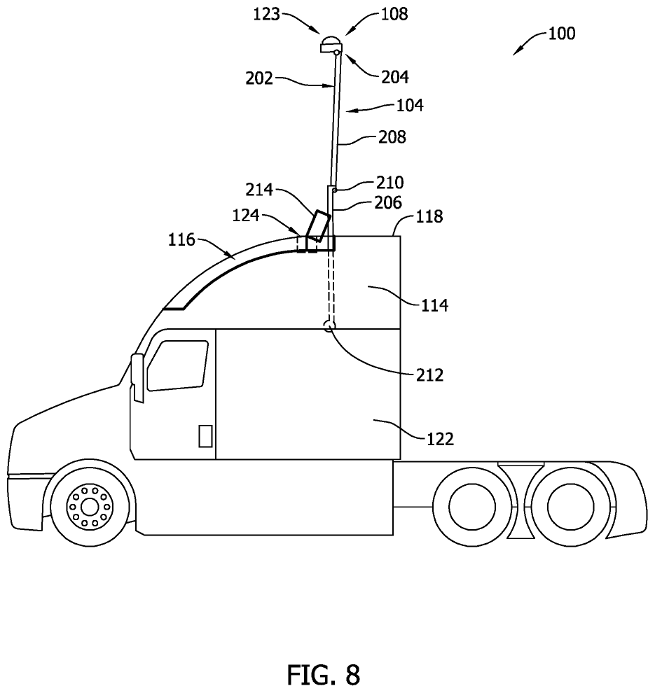

FIGS. 5-8 are views of the vehicle 100, including a second embodiment of the detection system 104 for perceiving the vehicle environment conditions around the autonomous vehicle. As shown in FIGS. 5-8, the second embodiment of the detection system 104 includes an arm 202, with the detection assembly 108 coupled to a top arm end 204 of the arm 202. The arm includes a first arm member 206 and a second arm member 208 pivotally connected to the first arm member 206 at an arm pivot 210. The second arm member 208 extends from the arm pivot 210 to the top arm end 204.

In the stowed configuration, the first arm member 206 and the second arm member 208 may be oriented to fit together, such as with the second arm member 208 positioned against and/or nested with the first arm member 206. In the extended configuration, the first arm member 206 is pivoted about an arm base pivot 212 and the second arm member 208 is pivoted about the arm pivot 210 for a maximum extension of the detection assembly 108 above the vehicle 100. The hatch 116 may extend towards a front of the vehicle 100 from the uppermost surface 118 adjacent the surface, to be opened, slid, and/or pushed aside when the arm 202 is extended to move the detection system 104 into the extended configuration. Additionally, a deployment hatch 214 may open when the arm 202 is extended. In the stowed configuration, the deployment hatch 214 may facilitate protecting the detection system 104 from precipitation, foreign particles, and/or weather damage.

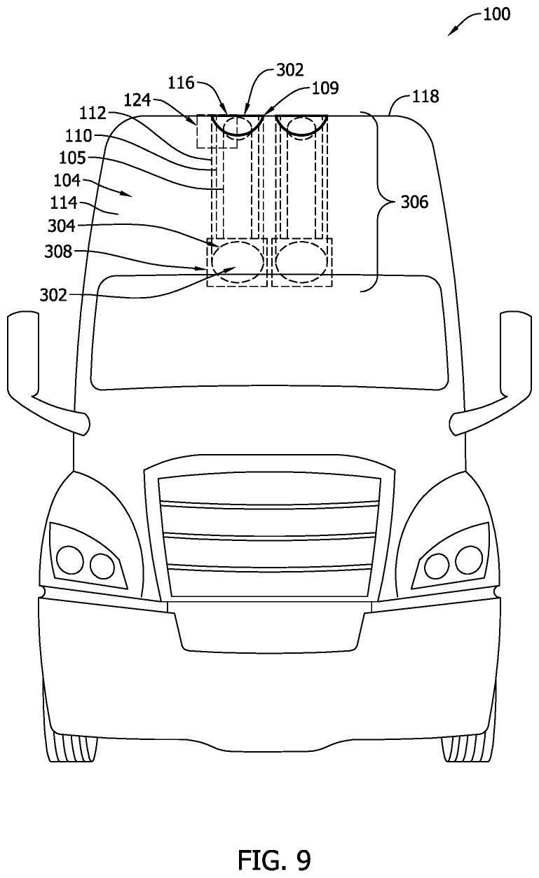

FIGS. 9-12 are views of the vehicle 100, including a third embodiment of the detection system 104 for perceiving the vehicle environment conditions around the autonomous vehicle. As shown in FIGS. 9-12, the third embodiment of the detection system 104 includes the base member 105 and the extension assembly 106. The extension assembly 106 includes the outer extension member 110 that slides within the base member 105 and the inner extension member 112 that slides within the outer extension member 110. The third embodiment of the detection system 104 also includes a pair of mirrors 302, each of the pair of mirrors 302 coupled to opposite ends of the extension assembly 106 (e.g., at the top end 109 of the extension assembly 106 and at a bottom end 304 of the extension assembly 106 opposite the top end 109).

The base member 105, the outer extension member 110, and the inner extension member 112 form a telescoping assembly, in that the sliding of the outer extension member 110 and the inner extension member 112 raise and lower the mirror 302 at the top end 109 of the extension assembly 106. In some embodiments, the telescoping assembly may include one or more actuators to extend the outer extension member 110 and the inner extension member 112. In other embodiments, the telescoping assembly may include one or more actuators to extend the outer extension member 110 and the inner extension member 112, such as, but not limited to, one or more springs.

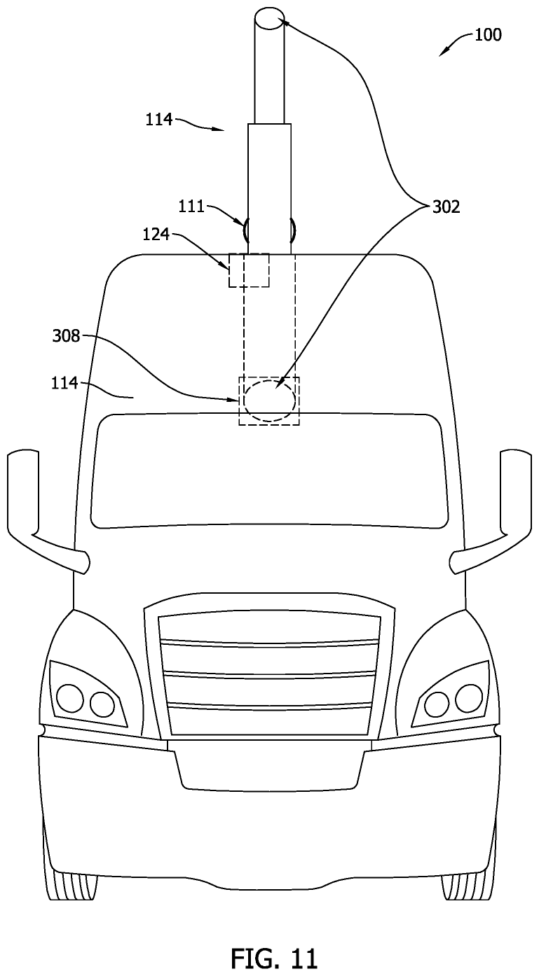

The extension assembly 106 may include one or more nesting members 111 (shown in FIG. 11) for engagement of the outer extension member 110 with the base member 105 and/or the inner extension member 112 with the outer extension member 110. For example, when the outer extension member 110 is extended through the base member 105 and/or the inner extension member 112 is extended through the outer extension member 110, the one or more nesting members 111 may secure the telescoping members in place at a maximum extension to facilitate improving the stability of the extension assembly 106.

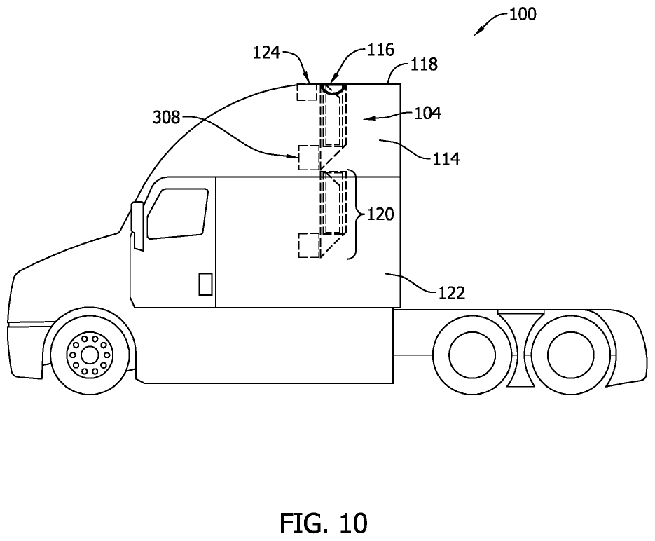

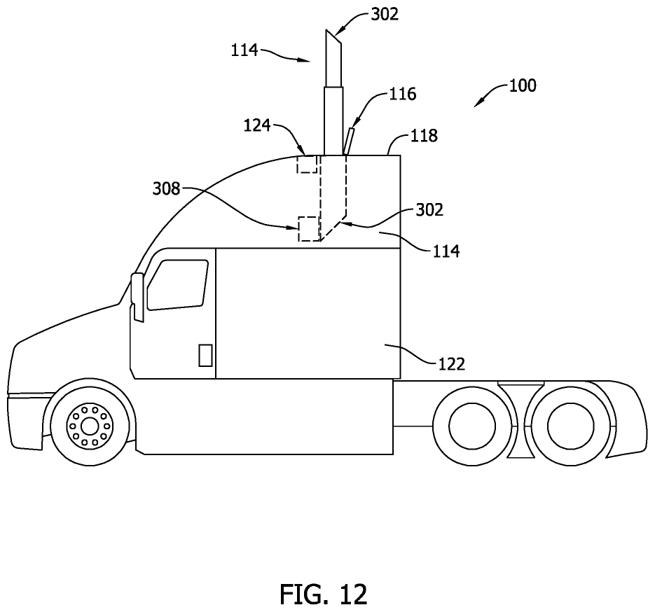

The detection system 104 moves between a stowed configuration, shown in FIGS. 9 and 10, and an extended configuration, shown in FIGS. 11 and 12. In the stowed configuration, the outer extension member 110 is nested within the base member 105 and the inner extension member 112 is nested within the outer extension member 110. The detection system 104 may be positioned within the upper cab area 114, with the hatch 116 on the uppermost surface 118 of the upper cab area 114 closed over the detection system 104 in the stowed configuration. The hatch 116 opens when the detection system 104 is moved into the extended configuration. In the stowed configuration, the hatch 116 may facilitate protecting the detection system 104 from precipitation, foreign particles, and/or weather damage.

The vehicle 100 may include an additional detection system 104 in a secondary position 306, as shown in FIG. 9. The position of the detection system 104 and/or the secondary position 306 within the upper cab area 114 is intended as illustrative, and is not meant to be limiting. The detection system 104 may be positioned elsewhere on the vehicle 100, such as, but not limited to, in the embedded position 120 within the main cab area 122 (shown in FIG. 10) below the upper cab area 114. For example, the detection system 104 may be in the embedded position 120 within the main cab area 122 if the vehicle 100 does not include an airfoil.

The detection system 104 may include one or more periscope sensors 308. The one or more periscope sensors 308 may be any sensor known in the art that facilitates the collection of data via periscope mirrors as related to the detection system 104. For example, the one or more periscope sensors 308 may include, but are not limited to, one or more light sensors, one or more light beam splitter devices, one or more light attenuator devices, one or more cameras, one or more LiDAR sensors, one or more RADAR cameras, and/or one or more stereo cameras (to collect three-dimensional images). The one or more periscope sensors 308 may be positioned proximate the bottom end 304 of the extension assembly 106.

Additionally, the detection system 104 may include the baseline sensor 124 positioned proximate the uppermost surface 118 of the upper cab area 114. The autonomy system 102 (shown in FIG. 20) may receive data from both the one or more periscope sensors 308 and the baseline sensor 124 to determine a height, a position, and/or an orientation of the detection assembly 108 and/or the extension assembly 106. Additionally, the autonomy system 102 (shown in FIG. 20) may receive data from at least one of the one or more sensors 123 and the baseline sensor 124 to detect impediments to extending the extension assembly 106 prior to extension. The baseline sensor 124 may be any sensor known in the art that facilitates the collection of data as related to the detection system 104. For example, the baseline sensor 124 may be a position sensor, a linear position sensor, a camera (including, but not limited to, an ocular camera and a stereo camera), and/or a LiDAR sensor.

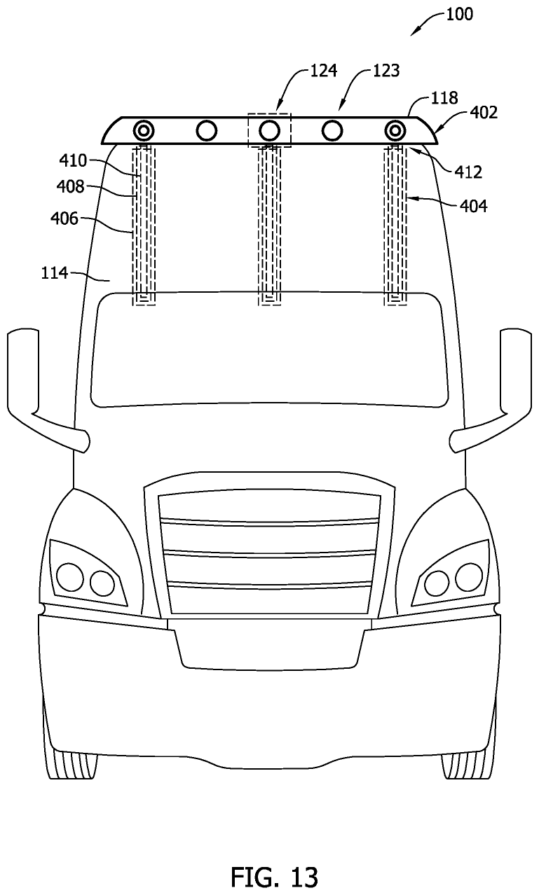

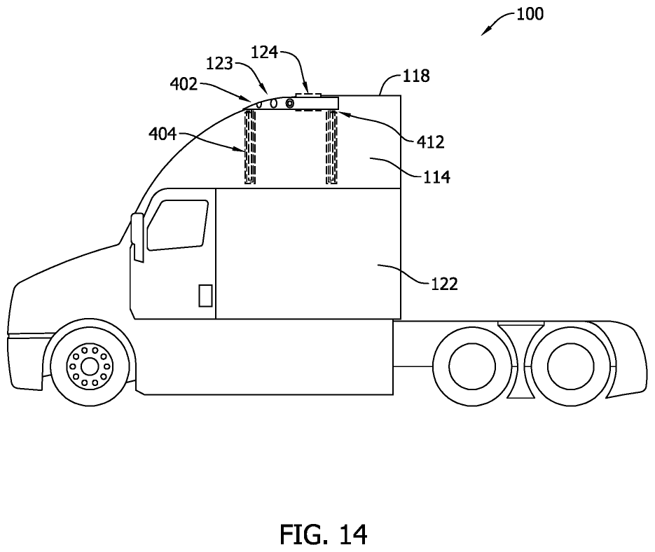

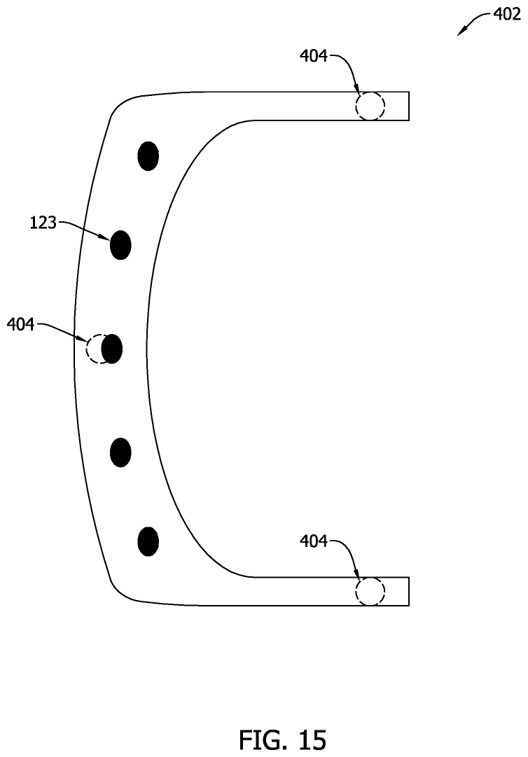

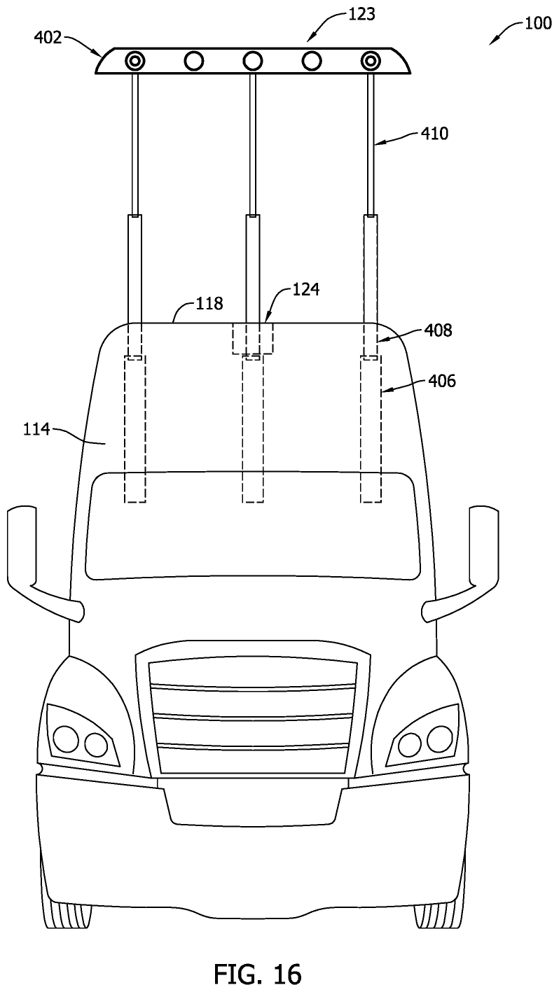

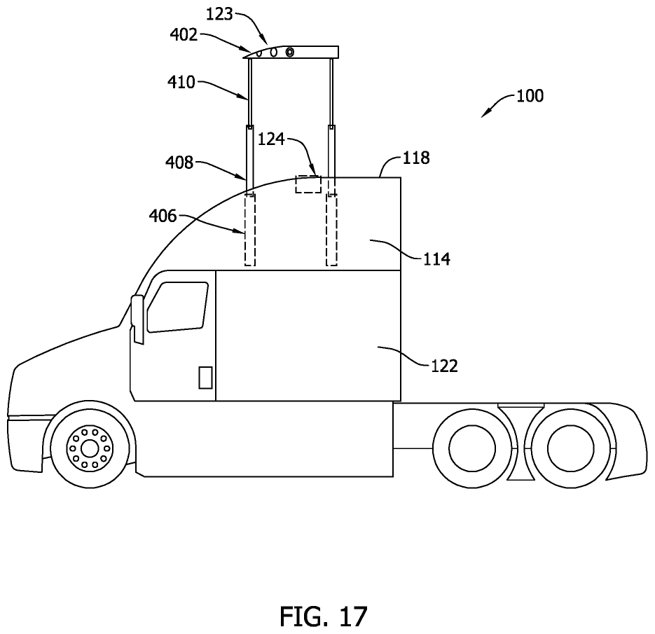

FIGS. 13 and 14 are views of the vehicle 100, including a fourth embodiment of the detection system 104 for perceiving the vehicle environment conditions around the autonomous vehicle. The fourth embodiment of the detection system 104 includes a platform 402 supported by one or more lifting assemblies 404. FIG. 15 is a top view of the platform 402. FIGS. 16 and 17 are views of the vehicle 100, including the fourth embodiment of the detection system 104. The platform 402 is positioned above the uppermost surface 118 of the upper cab area 114 of the vehicle 100.

Each of the one or more lifting assemblies 404 includes a base lifting member 406, an outer lifting member 408, and an inner lifting member 410. The one or more lifting assemblies 404 move the platform 402 between a lowered configuration, shown in FIGS. 13 and 14, and a lifted configuration, shown in FIGS. 16 and 17. In the lowered configuration, the outer lifting member 408 is nested within the base lifting member 406 and the inner lifting member 410 is nested within the outer lifting member 408. The use of multiple lifting assemblies 404 may facilitate increasing the stability of the detection system 104, such that sensors 123 having an increased weight may be supported by the platform 402 and/or the vehicle 100 may move at faster speeds while the platform 402 is raised.

The base lifting member 406, the outer lifting member 408, and the inner lifting member 410 form a telescoping assembly, in that the sliding of the outer lifting member 408 and the inner lifting member 410 raise and lower the platform 402 coupled to a top end 412 of the one or more lifting assemblies 404. In some embodiments, the telescoping assembly may include one or more actuators to extend the outer lifting member 408 and/or the inner lifting member 410. In other embodiments, the telescoping assembly may include one or more actuators to extend the outer lifting member 408 and/or the inner lifting member 410, such as, but not limited to, one or more springs. One or more sensors 123 may be coupled to the platform 402.

Additionally, the detection system 104 may include the baseline sensor 124 positioned proximate the uppermost surface 118 of the upper cab area 114. The autonomy system 102 (shown in FIG. 20) may receive data from both the one or more sensors 123 and the baseline sensor 124 to determine a height, a position, and/or an orientation of the detection assembly 108 and/or the extension assembly 106. Additionally, the autonomy system 102 (shown in FIG. 20) may receive data from at least one of the one or more sensors 123 and the baseline sensor 124 to detect impediments to extending the extension assembly 106 prior to extension. The baseline sensor 124 may be any sensor known in the art that facilitates the collection of data as related to the detection system 104. For example, the baseline sensor 124 may be a position sensor, a linear position sensor, a camera (including, but not limited to, an ocular camera and a stereo camera), and/or a LiDAR sensor.

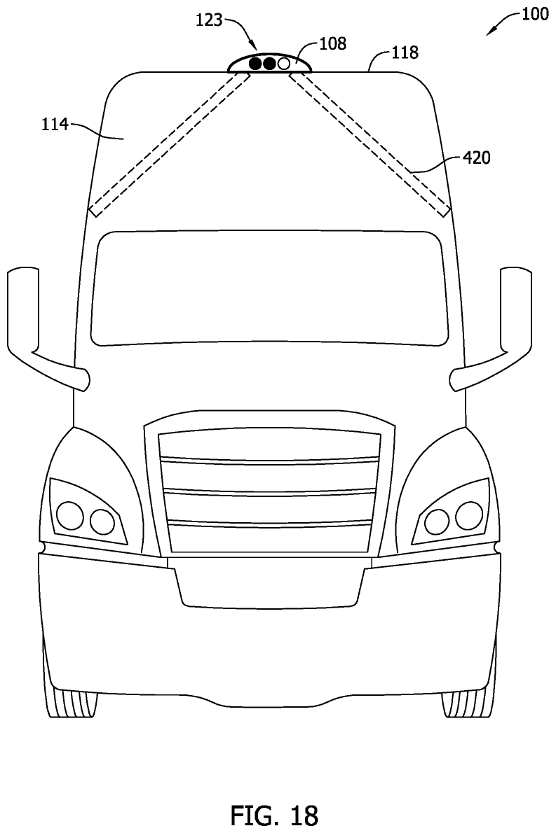

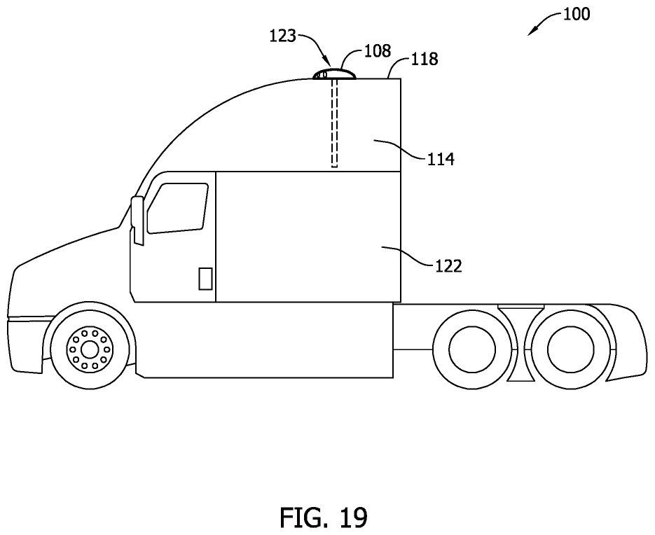

FIGS. 18 and 19 are views of the vehicle 100, including a fifth embodiment of the detection system 104 for perceiving the vehicle environment conditions around the autonomous vehicle. As shown in FIGS. 18-19, the fifth embodiment of the detection system 104 includes the detection assembly 108 mounted to the uppermost surface 118 of the upper cab area 114 of the vehicle 100. The detection assembly 108 may be mounted via one or more supports 420, and the number of supports 420 may depend on the weight of the sensors of the detection assembly 108.

Additional embodiments of the detection system 104 may include, but are not limited to, a scissor arm, an accordion arm, and/or one or more tethered drones. Thus, the embodiments of the detection system 104 as shown and described are intended as illustrative, and are not meant to be limiting.

FIG. 20 is a schematic of the autonomy system 102 for use with the vehicle 100. The autonomy system 102 may be used with any embodiment of the detection system 104 as described herein. The autonomy system 102 includes a controller 502 in communication with the detection system 104 and a plurality of sensors. The controller 502 may also be in communication with a drive system 504 to autonomously control movement of the vehicle 100. The controller 502 may be one or more processing systems. The controller 502 includes a memory 506 and a processor 508. The memory 506 may be any device allowing information such as executable instructions and/or data to be stored and retrieved. The processor 508 may include one or more processing units to retrieve and execute instructions and/or data stored by the memory 506.

The autonomy system 102 may use signals received from the plurality of sensors to control the detection system 104. The plurality of sensors may include, but are not limited to, the one or more sensors 123, the baseline sensor 124, and/or the one or more periscope sensors 308. The autonomy system may also use signals received from a server 510. The server 510 may be in communication with a computing device 512, such as, but not limited to, a user computing device (such as for manual remote control of the detection system 104) and/or another vehicle in communication with the vehicle 100 to send and/or receive signals between vehicles.

The autonomy system 102 may raise and/or lower the detection system 104 based on data received from the plurality of sensors and/or signals received from the server 510. For example, the height of the detection system 104 may be based on the speed of movement of the vehicle 100. When the detection system 104 is at a maximum height, the vehicle 100 may move at slower speeds, such as between approximately five and fifteen miles per hour. The speed of the vehicle 100 may additionally depend on the weight of the sensor(s) supported by the detection system 104, as additional weight at the maximum height may cause the detection system 104 to be less stable.

Additionally, for example, the height of the detection system 104 may be based on vehicle environment conditions proximate the vehicle 100 that are detected by the plurality of sensors. For example, the detection system 104 may be lowered from a raised height upon the detection of a hazard above the vehicle 100 or data indicative of an upcoming hazard above the vehicle 100, such as driving under a bridge or through a tunnel. Additionally, for example, the detection system 104 may be lowered from a raised height upon the detection of vibration (as caused by wind and/or movement of the vehicle 100, and as measured by an IMU) of the detection system 104 and/or the vehicle 100 above a desired stability vibration amount and/or upon the receipt of data indicative of undesirably high wind speeds and/or weather conditions.

Furthermore, for example, extension of the extension assembly 106 may be controlled based on detected objects and/or features proximate and/or above the vehicle 100 that may impede the use of the extension assembly 106 and/or the detection assembly 108. For example, the extension assembly 106 may be kept in a stowed configuration and/or lowered from an extended configuration if an object and/or a feature is detected above the vehicle 100, such as, but not limited to, a building feature, a tree, a flying object such as a drone, a bridge, an overpass, a traffic light, and/or a traffic sign.

The autonomy system 102 may also control motion and/or motion planning of the vehicle 100. For example, the autonomy system 102 may generate a map of one or more alternative routes for the vehicle 100 based on the vehicle environment conditions, such as based on a determination of a lane of traffic with a desired amount of movement, an upcoming exit to reroute the vehicle 100 away from the detected vehicle environment conditions and towards the destination, an alternate nearby road by which the vehicle 100 could move towards the destination, and/or a road shoulder and/or median to pull out of the way of oncoming emergency vehicles. Additionally, for example, the autonomy system 102 may control the movement of the vehicle 100 on a route selected from the one or more alternative routes. Furthermore, for example, the autonomy system 102 may determine a velocity and/or an acceleration of the vehicle 100 based on the collected sensor data.

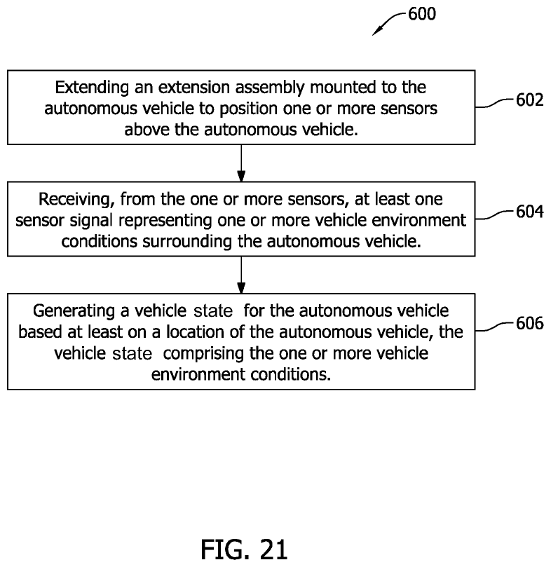

FIG. 21 is a flowchart of a method 600 of enhancing the sensing capabilities of the vehicle 100. The method 600 includes extending 602 an extension assembly (including, but not limited to, the extension assembly 106) mounted to the vehicle 100 to position one or more sensors (including, but not limited to, the one or more sensors 123) above the vehicle 100. The method also includes receiving 604, from the one or more sensors, at least one sensor signal comprising one or more vehicle environment conditions surrounding the vehicle 100. The method 600 also includes generating 606 a vehicle state for the vehicle 100 based at least on a location of the vehicle and the one or more vehicle environment conditions, such as, but not limited to, a construction zone, stopped or significantly slowed traffic, a road closure, and/or a suspected accident. Identifying the one or more vehicle environment conditions may include machine learning based on detected objects, such as cones and/or a blockage on the road for construction and emergency vehicles and/or flashing lights for a suspected accident.

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or a electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory may include, but is not limited to, a non-transitory computer-readable medium, such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable, and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A system for enhancing sensing capabilities of an autonomous vehicle, the system comprising:
a detection system comprising an extension assembly for mounting on the autonomous vehicle and one or more sensors; and
an autonomy system, the autonomy system including a controller, a processor, and a memory device, the memory device storing instructions that when executed by the processor cause the controller to:
extend the extension assembly to position the one or more sensors above the autonomous vehicle;
receive, from the one or more sensors, at least one sensor signal representing one or more vehicle environment conditions surrounding the autonomous vehicle; and
generate a vehicle state for the autonomous vehicle based at least on a location of the autonomous vehicle, the vehicle state comprising the one or more vehicle environment conditions.

2. The system of claim 1, wherein the extension assembly comprises a free end opposite a fixed end attached to the autonomous vehicle, and wherein the detection system comprises the one or more sensors coupled to the free end of the extension assembly.

3. The system of claim 1, wherein the extension assembly comprises an outer extension member and an inner extension member in a telescoping arrangement to extend the extension assembly, and wherein the extension assembly further comprises one or more actuators to extend at least one of the outer extension member or the inner extension member.

4. The system of claim 3, wherein the extension assembly further comprises one or more nesting members to secure at least one of the outer extension member or the inner extension member in place when the extension assembly is extended.

5. The system of claim 3, wherein the detection system further comprises a top mirror coupled to a free end of the extension assembly and a bottom mirror positioned proximate an uppermost surface of the autonomous vehicle, the one or more sensors positioned to detect signals received by the bottom mirror via the top mirror.

6. The system of claim 1, wherein the vehicle state is used for at least one of generating one or more alternative routes for the autonomous vehicle, moving the autonomous vehicle on a route selected from the one or more alternative routes, determining a velocity of the autonomous vehicle, or determining an acceleration of the autonomous vehicle.

7. The system of claim 1, wherein the detection system further comprises a baseline sensor positioned proximate an uppermost surface of the autonomous vehicle, the baseline sensor being configured to determine at least one of a position of the extension assembly, an orientation of the extension assembly, and a clearance above the autonomous vehicle to extend the extension assembly.

8. The system of claim 7, wherein extending the extension assembly comprises determining a height of the one or more sensors based on a measured distance between the one or more sensors and the baseline sensor.

9. The system of claim 1, wherein the extension assembly comprises a first arm member pivotally connected to the autonomous vehicle and a second arm member pivotally connected to the first arm member to extend the extension assembly.

10. The system of claim 1, wherein the extension assembly comprises a platform and one or more lifting assemblies to move the platform to extend the extension assembly.

11. A method for enhancing sensing capabilities of an autonomous vehicle, the method comprising:
extending an extension assembly mounted to the autonomous vehicle to position one or more sensors above the autonomous vehicle;
receiving, from the one or more sensors, at least one sensor signal representing one or more vehicle environment conditions surrounding the autonomous vehicle; and
generating a vehicle state for the autonomous vehicle based at least on a location of the autonomous vehicle, the vehicle state comprising the one or more vehicle environment conditions.

12. The method of claim 11, wherein extending the extension assembly comprises extending at least one of an outer extension member or an inner extension member oriented in a telescoping arrangement using one or more actuators.

13. The method of claim 12, wherein extending the extension assembly comprises positioning a top mirror above an uppermost surface of the autonomous vehicle and positioning a bottom mirror proximate the uppermost surface of the autonomous vehicle.

14. The method of claim 13, wherein receiving the at least one sensor signal comprises receiving a signal from the one or more sensors positioned to detect signals received by the bottom mirror via the top mirror.

15. The method of claim 11, wherein the vehicle state is used for at least one of generating one or more alternative routes for the autonomous vehicle, moving the autonomous vehicle on a route selected from the one or more alternative routes, determining a velocity of the autonomous vehicle, or determining an acceleration of the autonomous vehicle.

16. The method of claim 11, wherein receiving at least one sensor signal comprises receiving a signal from a baseline sensor positioned proximate an uppermost surface of the autonomous vehicle.

17. The method of claim 16, wherein extending the extension assembly comprises determining a height of the one or more sensors based on a measured distance between the one or more sensors and the baseline sensor, the baseline sensor being configured to determine at least one of a position of the extension assembly, an orientation of the extension assembly, and a clearance above the autonomous vehicle to extend the extension assembly.

18. The method of claim 11, wherein extending the extension assembly comprises extending at least one of a first arm member pivotally connected to the autonomous vehicle or a second arm member pivotally connected to the first arm member.

19. The method of claim 11, wherein extending the extension assembly comprises extending one or more lifting assemblies to move a platform.

20. An autonomy system for enhancing sensing capabilities of an automated autonomous vehicle, the autonomy system comprising a controller, a processor, and a memory device, the memory device storing instructions that when executed by the processor cause the controller to:
extend an extension assembly mounted to the autonomous vehicle to position one or more sensors above the autonomous vehicle;
receive, from the one or more sensors, at least one sensor signal representing one or more vehicle environment conditions surrounding the autonomous vehicle; and
generate a vehicle state for the autonomous vehicle based at least on a location of the autonomous vehicle, the vehicle state comprising the one or more vehicle environment conditions.
